(19) United States
(12) Patent Application Publication
(10) Pub. No.: US 2005/0076220 A1
(43) Pub. Date: Apr. 7, 2005

(54) Method and System for Using a Point System to Deliver Advertisement Emails and to Stop Spam

(76) Inventors: Xiao Quan Zhang, Cambridge, MA (US); Gordon Yaotsong Mo, Prospect Heights, IL (US)

Correspondence Address: GORDON Y. MO, 1109 OAK AVE., PROSPECT HEIGHTS, IL, 60070, US

(21) Appl. No.: 10/707,694

(22) Filed: Jan. 5, 2004

Related U.S. Application Data
(60) Provisional application No. 60/507,641, filed on Oct. 2, 2003.

(51) Int. Cl. H04L 9/00

(52) U.S. Cl. 713/176

(57) ABSTRACT

A method and system for issuing fingerprint keys and anti-spam points to meet the needs of email marketers to get their legitimate emails delivered without spamming recipients. Minimum modification to the recipient's email server is introduced to enable it to communicate with servers for registration/authentication purposes. For every email sent from a sender to a recipient using the system built upon the present invention, the sender's allotment of anti-spam points would be deducted by a fixed or varied number, depending on the specific implementation of the particular embodiment of the present invention. The method allows advertisers to buy anti-spam points from the service provider and provides a method to redistribute the payment to recipients of the advertisements.

### BACKGROUND OF INVENTION

1. Technical Field of the Invention

The present invention relates to the field of communications and, more particularly, to a method and system for deterring unwanted emails, and for giving advertisers an attractive way for email marketing.

2. Introduction

Unsolicited electronic mail, also called “junk email”, “spam”, or “UCE” (Unsolicited Commercial Email), costs email users hours every week sifting through and discarding hundreds of pesky and/or lewd messages. Ferris Research, an electronic-research firm, estimates that spam costs U.S. businesses $10 billion annually. And according to BrightMail Inc., a junk email filtering service provider, spam accounts for greater than 50% of all emails sent during summer of 2003.

There are several reasons that spam is a problem. First, it shifts costs: the cost of sending one spam is negligible, but if the number of spam is large, they create significant costs to ISPs (internet service providers) and to email recipients. The costs for the recipients are much greater than the costs of the sender. Spam creates an economic externality for spammers to benefit by shifting costs to others. Second, in order to attract customers and to circumvent filters, spams usually contain fraudulent information. Spammers can deceive in the “from” address, the IP address, the title, or the content. Third, due to the cognitive costs associated with sifting through emails, spam can displace normal emails. Over time, unless the growth of spam is impeded or stopped, it will severely hamper the usefulness and effectiveness of email as a communication tool.

On the legal ground, we see governments attempting to legislate against spam, but this method is of dubious value when spam readily flows from somewhere outside a government's jurisdiction. Furthermore, legal actions are very hard to enforce because a significant proportion of spam is sent via the insecure computers of unsuspecting users.

The battle against spam gets more and more intensified when spammers and spam-fighters are both upgrading their technologies rapidly. Anti-spam technology evolved from “from-address filtering”, “keyword filtering”, “IP address filtering”, “Bayesian filtering”, “fuzzy logic filtering” to “multi-user filtering”, each more powerful than its predecessors but the spammers are also well equipped with technologies; each time a new anti-spam method is developed, they will find a way to work around it. Although filtering is doing a marvelous job nowadays (Hotmail.com blocks 2 billion spams each day), spammers have shown great creativity in circumventing the methods used by the various filtering algorithms.

There are proposals for a change to the email protocol (SMTP) or the charging of a fee for each email message, but these are unlikely to occur because these would rely on international cooperation and simultaneous modification of email server systems or financial systems.

3. Prior Art

As shown in the introduction, there are several ways to address the problem of spam. On the legal ground, Villano (2003) discuses a law passed in California that empowers California residents, the state attorney general and Internet providers to seek civil damages against spammers amounting to $1,000 per e-mail and $1 million per incident. UK has recently passed a law to ban spam; it will be illegal for UK companies to send spams to individuals unless they are already a customer or have given their permission. If they break the law they could be fined £5,000. These legal efforts can deter some spammers, but they suffer practical drawbacks including, but not limited to the following: 1) all legal systems are limited by jurisdiction; it is hard to convict spammers from other parts of the world; 2) spammers can use various technologies to conceal their identity; it is very costly to identify spammers; 3) the current anti-spam laws are susceptible to malicious claims and thus hurting legitimate email communications (See, for example, Rapoza, 2003); 4) there is no authoritative definition of “spam”, thus there are gray areas that spammers can exploit.

Built upon keyword parsing, many filtering-based techniques are used in reality. The first generation of filtering consists of naive “from address” blocking or “content key-words” blocking (McCormick et al., U.S. Pat. No. 6,023,723). These filters can be easily circumvented if the spammers fake their identities or conceal the content by rephrasing. Stockwell et al. (U.S. Pat. No. 6,072,942) proposed a mechanism of interconnected node filtering that combines various filtering techniques to provide protection. Fleming, III (U.S. Pat. No. 6,249,805) proposed to censor the sender's identifications by a set of rules, if the sender meets the criteria, the message will be put in the inbox, and otherwise, the message will be put in some junk-mail box for further examination. Donaldson (U.S. Pat. No. 6,321,267) suggested probing the source computer for connect-time IP address, testing the dialup PC's attempt to send multiple emails, testing for permissive open relays, and from-address and message-header filtering. Cotton (U.S. Pat. No. 6,330,590) suggested a simple way to distinguish spams from normal emails, if an email server detects a set of typically three identical messages going to different email recipients, the message will be flagged as spam. McCormick et al. (U.S. Pat. No. 6,421,709) proposed a two-layer filtering technique, by which a user can compile a list of rules to filter out spams, and at the same time, the user can compile a list of other rules to exclude some messages from being filtered out. This patent also introduced the first attempt to use collaborative efforts to filter messages. Riemers (U.S. Pat. No. 6,615,242) proposed a way of identifying URLs from email messages and using the content extracted from the URL to enhance the filtering result. Many of the filtering-based techniques are enhanced by statistics reasoning and fussy logic (for example: Horvitz et al's U.S. Pat. No. 6,161,130; Leeds's U.S. Pat. No. 6,393,465). All these filtering techniques are limited in their power of deterring spam. They are either too specific such that spammers can easily bypass the rules, or too broad such that legitimate emails tend to be filtered. All filtering-based techniques rely on rules, BrightMail and some other anti-spam firms hire many people to work full time to write these rules. Whenever a rule is written, there will be ways for spammers to work around it. For end users, if it is bearable to have some missed spams in the inbox, it is usually unacceptable to get some legitimate emails filtered away as spams. Recently, there are proposals for peer-to-peer filtering schemes, where email users form a group to collaboratively determine which emails are spams (for example: McCormick et al., U.S. Pat. No. 6,421,709; Nielsen, U.S. Pat. No. 6,453,327). These methods rely on homogeneity of email users heavily, if the spam is only for a few of the group members, or if an important message to one member is not valued as high by others, these methods fail. Since filtering-based techniques rely on rules and keywords, some spammers are creating random strings in the email to confuse the filtering systems. The systems can not simply mark all emails with random strings as spams because they might be written in some foreign language. Spammers can also send a picture of texts to promote business without fearing about keyword search. Another big drawback about filtering-based techniques is that instead of deterring spams, they encourage spams: when the systems can filter out 98% of the spams, the spammers are increasing the number of spams to hit the 2% that indeed go through, this makes the Internet more congested. As the spammers learn and improve their writing skills, spams are even harder to be distinguished from normal emails, making it more likely to filter away some important emails.

Another interesting way of eliminating spams is to change email protocols. For example, Hall (U.S. Pat. No. 5,930,479) proposed to use a channelized address to ensure that the sender is authorized to send the emails. Skopp et al (U.S. Pat. No. 6,256,739) proposed to use two protocols to authenticate the sender. Schwartz et al (U.S. Pat. No. 6,473,758) suggested creating a database of unique address identifications, and the email protocol needs to be changed to accommodate these ID's for each possible sender. These methods are powerful if implemented, and they have the potential to truly deter spammers. Apart from the drawback of privacy concerns, they are not feasible. The Internet is an open system; email servers are using compatible protocols to communicate with each other. If the protocol is changed or modified on only a proportion of servers, the power of these methods will collapse: machines using the new protocol have to be able to accept emails from those using the old protocol, and the spammers can simply send spams from machines using the old protocol. The cross-country, cross-platform, cross-language simultaneous change of the email protocol is thus not feasible.

There are some people proposing to ask the spammers to include “ADV”, or “SPAM” in the subject line of their commercial emails. Ogilvie et al (U.S. Pat. Nos. 6,487,586 and 6,487,586) and Pang (U.S. Pat. No. 6,493,007) suggested to enable a “self removing” function for email senders to choose a duration of life for emails sent. These are not feasible because there is simply no incentive for spammers to use these measures. If all the email users block emails with subject line containing “ADV” or “SPAM”, or block all those emails with self-removing date, no one would ever send out an email with them.

Recently, people are proposing another kind of anti-spam technique called “challenge-response” systems. Heiner (U.S. Pat. No. 6,112,227) is the first to propose sending an email back to the sender asking the sender to register at the recipient's server. Cobb (U.S. Pat. No. 6,199,102) improved it proposing sending an email back to the sender and ask the sender a question which is easy for human beings but not easy for machines. Kirsch (U.S. Pat. No. 6,546,416) further improved it by assigning a key to each unverified email, and let emails through if a response key is matched. These methods are more practical than those that change protocols, and more reliable than filtering-based techniques. However, they suffer practical drawbacks including, but not limited to the following: 1) they need a lot of sender's cognitive input, which can be very high if the sender needs to send legitimate emails to a large list. 2) For one message, there will be multiple exchanges of emails, making it not very cost effective. 3) If there is an emergency, the sender may not have a chance to wait before the desk to reply the challenge question. 4) The challenge questions may not be suitable for people from foreign countries or people with disabilities.

Council et al (U.S. Pat. No. 6,587,550) proposed to use an electronic billing system to charge a fee from the unverified senders. This creates a marginal cost for spammers if they want to get the emails through. This method suffers from practical drawbacks including, but not limited to: 1) the value of sending an email can be very small; it is not practical to charge a fee at the level of 1/10 of a cent. There are also international currency exchange problems. 2) For this small fraction of a cent's money, the sender's associated cognitive cost is enormous; this method suffers all the drawbacks of “challenge-response” systems. 3) Charging a fee for sending email is not socially efficient because the marginal cost of sending an email is lower than the fee charged. This is similar to a tax on email, and it creates a loss in consumer surplus.

### SUMMARY OF INVENTION

The above-mentioned drawbacks are overcome and a practical advance is made over the prior art through the method and system of the present invention.

In a first aspect, the invention features a method for sending an email from an email sender to a recipient in a network. The method comprises the authentication of a sender and once verified, delivering the email to the recipient.

In another aspect of the invention, a method for sending the sender's email address along with a unique fingerprint key to an email management system for verification is provided. This email management system, hereinafter, is referred to as the Email Chief (see FIG. 1). The Email Chief comprises one or multiple interconnected computers residing at a single or multiple locations. The method comprises a secure communication between the email recipient's email server and the Email Chief for registration/authentication purposes.

In another aspect of the invention, a simple and effective method of differentiating spammers from non-spammers is provided. The method comprises verifying the sender's fingerprint key and deducting sender's anti-spam points before acknowledging the recipient's email server to deliver the email.

In another aspect of the invention, a system for registering email senders and issuing and verifying the said fingerprint keys and the said anti-spam points is provided. The system comprises the Email Chief for issuing and verifying the fingerprint keys, and issuing and deducting the points. The system makes available an online registration form, and when the sender completes the form, the system would issue a certain number of free (no charge) anti-spam points, hereinafter referred to as Pass Points. One or more files are available to the Email Chief for determining whether the email sender's address is registered, whether the email sender's fingerprint key is correct, and whether the email sender's points are sufficient.

In another aspect of the invention, a method of requesting a sender to register at the Email Chief is provided. The method comprises the steps of: 1) sender sending an email to the recipient, 2) the recipient's email server or email client communicating with the Email Chief to determine whether the sender has provided the fingerprint key in the email, 3) in cases either the sender has not provided the fingerprint key or the sender has provided an incorrect fingerprint key, the Email Chief asking the recipient's server to hold the email, and 4) the Email Chief sending a message to the sender requesting the sender to register.

In another aspect of the invention, a method of acknowledging delivery of the email and deducting the anti-spam points is provided. The method comprises the steps of: 1) the Email Chief checking the file to verify the sender is registered and the provided fingerprint key is correct, 2) acknowledging the recipient's email server or email client to deliver the email, and 3) deducting the appropriate anti-spam points from the sender.

In another aspect of the invention, a method enabling legitimate advertisers to buy advertisement points hereinafter referred to as Ad Points, from the Email Chief operator, and enabling the Email Chief operator to reward email recipients for their earned Ad Points. The method comprises the steps of: 1) advertiser purchasing Ad Points from Email Chief operator, 2) advertiser sending emails to recipient, 3) Email Chief acknowledging the recipient's server or email client to deliver the email, 4) Email Chief deducting the Ad Points from the advertiser, and 5) Email Chief operator rewarding email recipients earned Ad Points.

In another aspect of the invention, a system enabling email recipients to set one or more values for charging advertisers' Ad Points. The system comprises one or more records, for each email recipient, of the number of Ad Points he or she would like to charge for each email going to him or her. The system comprises the capability to deduct a fixed or varied number of points if the sender's anti-spam points are issued through the registration process; and the capability to deduct the number of points required by the recipient if the sender's anti-spam points are purchased from the Email Chief operator.

In another aspect of the invention, a system capable of limiting the number of email accounts from which each individual could redeem Ad Points for reward.

In another aspect of the invention, a system capable of increasing or decreasing, on a fixed or varied schedule, an account's Pass Points to any chosen value or range.

In another aspect of the invention, a system capable of catering to the language of the user during registration, or for any other interaction with the system.

In another aspect of the invention, a system enabling domain owners to issue anti-spam points to email users for emails delivered only to within that same domain. These domain restricted anti-spam points are hereinafter referred to as Dom Points.

In another aspect of the invention, a system enabling email users to acquire anti-spam points for the safe passage of their solicited emails. These safe passage anti-spam points are hereinafter referred to as Safe Points. Safe Points are typically used by mailer sending out large quantities of solicited emails. Such solicited emails, for example, include periodic newsletters, responses to inquiries, and automatic notifications.

In another aspect of the invention, a system capable of tracking registered users' email usage patterns to establish user classification.

The differences between prior arts and the present invention are numerous and significant.

1) The present invention is not rule-based or keyword-based, thus there is no danger of filtering away an important email. It starts protecting an email user immediately after his email server is communicating with the Email Chief.

2) There is no need to change the current email protocols, the only information exchanged between the email server and the Email Chief is the encoded string containing the sender's email address and the fingerprint key, and the authenticating process can be easily implemented by writing a computer program to interact with both the email server program and the Email Chief. It is no more complex than the programs run by many email servers for filtering emails.

3) With the fingerprint key, a user is protected from spammers stealing his or her identity or email address to send out spams.

4) Only a one-time registration is required for the email sender. Once registered, the system will automatically replenish the anti-spam points of the email users after a fixed or varied period of time has elapsed. The number of emails permitted to be sent using the present invention within a certain period of time thus is limited, effectively distinguishing spammers from normal email users.

5) The user registration process is meant to incur some cognitive costs for the email sender. Users are able to omit sensitive information if they so desire.

6) The sender would need to register only once at the Email Chief for all participating email servers or email clients to verify the identity of the sender. It is much more feasible and convenient than previous solutions that require registration at each email server.

7) Comparing with the challenge-response systems, the present invention does not require the recipient to build a trusted list. Once registered, a legitimate sender does not need to answer challenge questions each time he or she sends an email to a recipient who does not have his or her email address in the trusted list.

8) Normal usage of sending and receiving emails would not incur any expense to the sender. High volume users could acquire Dom Points or Safe Points.

9) The present invention enables the email recipients to set a personal threshold for charging Ad Points. Different people with different opportunity costs can charge different number of Ad Points and redeem them later for money, goods, and/or services.

The present invention creates a legitimate venue for email marketing. The advertisers can buy Ad Points and set a threshold value for sending out each email. If the recipient's threshold value is lower than the advertiser's threshold value, then the email will be delivered, and if not, the email will not be delivered. For a recipient, he or she sets a threshold value according to his or her opportunity cost. If receiving the email pays him or her acceptable price, he or she is better off to read the email; on the other hand, if the email's value is lower than his or her threshold value, the email will not get through.

Hereinafter, an email bearing Ad Points will be referred to as Ad email. Similarly, an email bearing Dom, Free, or Safe Points will be referred to as Dom email, Free email, or Safe email, respectively.

There are still other differences, both major and minor, between the prior arts and the present invention. Those differences just listed, however, suffice to show that the prior arts are only marginally pertinent to the present invention. It has been useful to discuss it here, however, as the comparison highlights some of the advantages of the present invention. More advantages are discussed in the following sections.

### BRIEF DESCRIPTION OF DRAWINGS

FIG. 1 provides a simplified block diagram of an email system according to an embodiment of the present invention. It is used to show the physical process of email communication suggested by the present invention.

### DETAILED DESCRIPTION

Description and Operation of Invention

The present invention will now be described with reference to the accompanying drawings, which are provided as illustrative examples of preferred embodiment of the present invention.

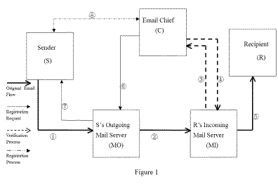

FIG. 1 depicts a preferred embodiment of a system performing the functions stated in the present invention. The system includes a sender's computer (S), a recipient's computer (R), the sender's SMTP email server (MO), the recipient's email server (MI), and the Email Chief (C) for registration/authentication purposes. The present invention can be deployed at the recipient's email server (M1) or at the recipient's email client software (R), and at the Email Chief (C). The Email Chief (C) has the function for registration, authentication, and maintenance of database.

The recipient's communications device may be any communications device capable of receiving electronic mail or instant messages, such as a computer running mail client software, a Web-enabled wireless telephone, a wireless personal digital assistant, a pager, or the like. For discussion purposes, the following discussion considers a general-purpose computer running mail client software.

In this preferred embodiment, the anti-spam points are categorized into four types: Pass points, Dom points, Safe points, and Ad points. The Pass points and Dom points are issued free of charge, while the Safe points and Ad points are required to be purchased.

Pass points are typically used by people who could be described as “normal email users.” These are people who do not send out huge volume of emails. Any email user could obtain Pass points free of charge after completing a registration form online.

Dom points are typically used by domain owners who have the need to send large quantities of emails to email addresses within their own domain. Emails that are sent using Dom points could only be received by email addresses having the same domain name as the sender. For example, using Dom points, an email from john@aaa.com could be sent to mary@aaa.com, and not to jane@bbb.com.

Safe points are typically used by businesses or by people who sends out large quantities of solicited emails. Safe points guarantee that the emails would get delivered. Examples of solicited emails include newsletters, automatic confirmation email for purchases, email replies from customer service representatives, car rental reminders, bill payment notices, etc. For each email, the senders would need to purchase an amount of Safe points adequate to cover for the number of emails addresses they wish to send to.

Purchased Ad points are typically used by reputable email marketers who are mindful of the negative effects of spamming their potential customers. For each advertisement email, the email marketer would set a limit on the number of Ad points offered to the recipients. The advertisement email would only be delivered to recipients who have set a threshold value for charging paid Ad Points that is lower than the value of Ad points offered.

In terms of its function for registration, the Email Chief C can send registration requests to email senders that are not in the current pool of registered users, can communicate with email senders, can issue a fingerprint key for each email address after a successful registration, can issue a certain amount of free Pass Points for the email address, and can replenish or infuse it with more Pass Points after a fixed or varied period of time. These free Pass Points will be deducted by a fixed or varied number each time the user sends out an email to the email servers adopting the present invention. These free Pass Points will be automatically replenished for the user after a fixed or varied period of time has elapsed. The amount of free Pass Points is chosen such that they are ample for normal email users, and at the same time not ideal for spamming (According to BrightMail Inc., an average spammer sends out 250,000 emails each day, so the chosen amount of free Pass points can be very large). For example, if one Pass point is good for sending an email to a single email address, a user is issued 3,000 Pass points per calendar month subject to the following usage rate limitations: 50 Pass points per minutes, limited to 200 Pass points per any 10-minute period, 500 Pass points per calendar day, and 1500 Pass points per calendar week.

Those organizations and users having a legitimate need to send more emails than the quota can purchase Safe Points to meet their high volume needs. The cost of Safe Points is refundable to the buyer once the email bearing the Safe Points, or Safe Email, has been accepted by the email recipient. On the other hand, if the recipient claims that the Safe email is spam, the Safe Points used for delivering the email to that recipient are forfeited.

Those advertisers having a need to send out unsolicited commercial emails can purchase Ad Points from the company running the Email Chief. These paid Ad Points are different from the free Pass Points in that they may be deducted by a threshold value set by the recipient. The Email Chief would keep a record of which email addresses have received paid commercial emails, and it can reward money, goods, and/or services to these recipients when they redeem their earned Ad Points.

In terms of its function for authentication, the Email Chief can communicate with the recipient's email server or email client to compare the sender's fingerprint key with the record in the databases, can deduct the appropriate types of anti-spam points from the email senders, and can command the recipient's email server or email client to make the verified email available to the recipient.

With reference to FIG. 1, in step 1, the sender (S) sends out the email to the outgoing email server (MO); in step 2, the outgoing server (MO) transmits the email to the recipient's incoming email server (MI); before making the email available for the recipient (R), the incoming server (MI) contacts the Email Chief (C) in step 3, by sending an encoded string which contains the sender's profile including, but not limited to the sender's email address, the recipient's email address, MI's identification code, the sender's fingerprint key (if provided); if the Email Chief (C) can match the fingerprint key with the one in the record for the given email address, it will, in step 4, deduct the appropriate anti-spam points of the sender (S) and send an acknowledgment to the incoming email server (MI) or the recipient's email client software to instruct it to make the email available for downloading; in step 5, when the recipient (R) checks his or her email, the email will be delivered to him or her. On the other hand, if in step 3, the Email Chief (C) can not find the fingerprint key, or the fingerprint key is invalid, the Email Chief (C) will send an email to the original email sender (S) and will ask (S) to register at (C); the registration request is sent through steps 6 and 7; in step 8, the sender (S) goes to the Email Chief (C) to get registered; the Email Chief (C) will offer the sender a unique fingerprint key and some free Pass Points. After a successful registration, the Email Chief (C) can then continue with step 4 to acknowledge making the email available for downloading at the incoming email server (MI); if in step 3, the sender runs out of free anti-spam points, he or she can elect to purchase Ad Points or Safe Points, depending on his or her needs. If step 8 is never carried out, and the email server (MI) is not able to receive an acknowledgment, the email server (MI) or email client software can elect to delete the email after a certain period of time or to add a flag to the message and let the recipient choose further actions.

A few scenarios are described in detail with reference to FIG. 1.

In one scenario, sender S has not registered. With reference to FIG. 1, in step 1, the sender S sends the email to the outgoing email server MO; in step 2, the outgoing server MO transmits the email to the recipient's incoming email server MI; before making the email available for the recipient R, the incoming server MI contacts the Email Chief C in step 3, by sending an encoded string which contains the sender's email address, the recipient's email address, MI's identification code; On the other hand, if in step 3, the Email Chief C can not find the fingerprint key, and therefore sends an email to the original email sender S asking S to register at B; the registration request is sent through steps 6 and 7; in step 8, the sender S goes to the Email Chief C to get registered; the Email Chief C will offer the sender a unique fingerprint key and some free Pass Points. After a successful registration, the Email Chief C can then continue with step 4 to acknowledge making the email available for downloading at the incoming email server MI. If step 8 is never carried out or not carried out satisfactorily, and the email server MI is not able to receive an acknowledgment, the email server MI or email client software can elect to delete the email after a certain period of time or to add a flag to the message and let the recipient choose further actions.

In a second scenario, the sender S is a registered user. With reference to FIG. 1 again, in step 1, the sender S sends the email to the outgoing email server MO; in step 2, the outgoing server MO transmits the email to the recipient's incoming email server MI; before making the email available for the recipient R, the incoming server MI contacts the Email Chief C in step 3, by sending an encoded string which contains the sender's email address, the recipient's email address, MI's identification code, the sender's fingerprint key (if provided); if the Email Chief C can match the fingerprint key with the one in the record for the given email address, it will, in step 4, deduct the appropriate amount of Pass points of the sender S and send an acknowledgment to the incoming email server MI or the recipient's email client software to instruct it to make the email available for downloading; in step 5, when the recipient R checks his or her email, the email will be delivered to him or her. On the other hand, if in step 3, the Email Chief C can not find the fingerprint key, or the fingerprint key is invalid, the Email Chief C will send an email to the original email sender S asking S to validate the fingerprint key at B; the validation request is sent through steps 6 and 7; in step 8, the sender S accesses the Email Chief C's web site and enters the correct fingerprint key. After a successful validation, the Email Chief C can then continue with step 4 to acknowledge making the email available for downloading at the incoming email server MI; if in step 3, the sender runs out of free spam points, he or she can elect to purchase Ad Points or Safe Points, depending on his or her needs. If step 8 is never carried out or not carried out satisfactorily, and the email server MI is not able to receive an acknowledgment, the email server MI or email client software can elect to delete the email after a certain period of time or to add a flag to the message and let the recipient choose further actions.

In a third scenario, sender S has purchased Safe points. With reference to FIG. 1 furthermore, in step 1, the sender S sends the email to the outgoing email server MO; in step 2, the outgoing server MO transmits the email to the recipient's incoming email server MI; before making the email available for the recipient R, the incoming server MI contacts the Email Chief C in step 3, by sending an encoded string which contains the sender's email address, the recipient's email address, MI's identification code, the sender's fingerprint key (if provided); if the Email Chief C can match the fingerprint key with the one in the record for the given email address, it will, in step 4, deduct from sender S′ account the appropriate amount of Safe points, and send an acknowledgment to the incoming email server MI or the recipient's email client software to instruct it to make the email available for downloading; in step 5, when the recipient R checks his or her email, the email will be delivered to him or her. On the other hand, if in step 3, the Email Chief C can not find the fingerprint key, or the fingerprint key is invalid, the Email Chief C will send an email to the original email sender S asking S to validate the fingerprint key at B; the validation request is sent through steps 6 and 7; in step 8, the sender S accesses the Email Chief C's web site and enters the correct fingerprint key. After a successful validation, the Email Chief C can then continue with step 4 to acknowledge making the email available for downloading at the incoming email server MI; if in step 3, the sender runs out of Safe points, the Email Chief C will send an email to the original email sender S asking S to purchase for Safe points; the validation request is sent through steps 6 and 7; in step 8, the sender S accesses the Email Chief C's web site and buys more Safe points. After acquiring more Safe points, the Email Chief C deducts the appropriate amount of Safe points from S's account, and then continues with step 4 to acknowledge making the email available for downloading at the incoming email server MI. If step 8 is never carried out or not carried out satisfactorily, and the email server MI is not able to receive an acknowledgment, the email server MI or email client software can elect to delete the email after a certain period of time or to add a flag to the message and let the recipient choose further actions.

In a fourth scenario, sender S has purchased Ad points. With reference to FIG. 1 yet again, in step 1, the sender S sends the email to the outgoing email server MO; in step 2, the outgoing server MO transmits the email to the recipient's incoming email server MI; before making the email available for the recipient R, the incoming server MI contacts the Email Chief C in step 3, by sending an encoded string which contains the sender's email address, the recipient's email address, MI's identification code, the sender's fingerprint key (if provided); if the Email Chief C can match the fingerprint key with the one in the record for the given email address, and verifies that the limit on the number of Ad points offered to the recipients meets or exceeds the threshold value for charging paid Ad Points set by the recipient R, then B deduct from sender S′ account the number of Ad points that matches R's threshold value, and credits them to R's account. In step 4, B then send an acknowledgment to the incoming email server MI or the recipient's email client software to instruct it to make the email available for downloading; in step 5, when the recipient R checks his or her email, the email will be delivered to him or her. If, in step 3, B verifies that the limit on the number of Ad points offered to the recipients does not meet or exceed the threshold value for charging paid Ad Points set by the recipient R, then B send a command, in step 4, to the incoming email server MI or the recipient's email client software to instruct it to delete the email. On the other hand, if in step 3, the Email Chief C can not find the fingerprint key, or the fingerprint key is invalid, or Ad points is depleted or inadequate, the Email Chief C will, in step 4, send a command to the in incoming email server MI or the recipient's email client software to instruct it to delete the email. In the case where Ad points is depleted, in step 5, B would send and email to S notifying that Ad points ran out and to provide a link to a web site for accessing a detailed report on this email advertisement campaign.

In a fifth scenario, the sender S is a registered user and has acquired Dom points. With reference to FIG. 1 once more, in step 1, the sender S sends the email to the outgoing email server MO; in step 2, the outgoing server MO transmits the email to the recipient's incoming email server MI; before making the email available for the recipient R, the incoming server MI contacts the Email Chief C in step 3, by sending an encoded string which contains the sender's email address, the recipient's email address, MI's identification code, the sender's fingerprint key (if provided); if the Email Chief C can match the fingerprint key with the one in the record for the given email address, it will, either deduct the appropriate amount of Pass points of the sender S if the recipient R's email address does not share the same domain as the sender, or deduct the appropriate amount of Dom points of the sender S if the recipient R's email address shares the same domain as the sender; and, in step 4, send an acknowledgment to the incoming email server MI or the recipient's email client software to instruct it to make the email available for downloading; in step 5, when the recipient R checks his or her email, the email will be delivered to him or her. On the other hand, if in step 3, the Email Chief C can not find the fingerprint key, or the fingerprint key is invalid, the Email Chief C will send an email to the original email sender S asking S to validate the fingerprint key at B; the validation request is sent through steps 6 and 7; in step 8, the sender S accesses the Email Chief C's web site and enters the correct fingerprint key. After a successful validation, the Email Chief C can then continue with step 4 to acknowledge making the email available for downloading at the incoming email server MI; if in step 3, the sender runs out of Dom points, Pass points get deducted instead; and if both Dom and Pass points are out, he or she can elect to purchase Ad Points or Safe Points, depending on his or her needs. If step 8 is never carried out or not carried out satisfactorily, and the email server MI is not able to receive an acknowledgment, the email server MI or email client software can elect to delete the email after a certain period of time or to add a flag to the message and let the recipient choose further actions.

In the preferred embodiment, the fingerprint key is a string chosen by the email sender during registration. The fingerprint key is typed in the body of the email as if it is part of the email message. Each fingerprint key shares a common characteristic with all other fingerprint keys. It is this common characteristic which makes the fingerprint key recognizable by this invention's software that is installed on the email server MI. Prior to releasing the email to the recipient R, MI removes the fingerprint key from the email, and therefore it is not seen by the recipient R.

In the preferred embodiment, two methods are available to safeguard the Ad points from being stolen during the transmission of the Ad email. In the first method, the email marketer is required to logon to the Email Chief's web site to send the Ad email through the site's web page. In addition, the email marketer would have to purchase Ad points for each mailing, i.e., buying one batch of Ad points good for sending one email to a list of recipients once; and sending the same email again would require the purchase of a new batch of Ad points. In the second method, the email marketer would use a digital signature certificate generated by cryptographic software, as is well known in the art, for the authentication of the Ad email.

In another embodiment of the present invention, the function of holding the email and communicating with the Email Chief can be done by the recipient's email client.

In another embodiment of the present invention, if step 8 is never carried out, the email server can elect to edit the email by adding a flag in the header of the email, and let the recipient decide what to do with the email. The recipient can elect to write a rule of filtering in his or her email client software to filter the emails with the flag to a separate folder or to delete it directly.

In another embodiment of the present invention, the email server MI can elect to make available the email for the recipient immediately and then communicate with the Email Chief C.

In another embodiment of the present invention, the recipient's threshold value for charging paid Ad Points can be omitted from the system, and all anti-spam points, whether free or purchased will be treated the same way, and each delivery of an email will result in a deduction of a predetermined fixed or varied number of points from the email sender.

In another embodiment of the present invention, if a sender has not registered with the Email Chief, either the Email Chief or the incoming email server of the recipient would send an email to notify the sender that his or her email is on-hold and will not be delivered until he or she registers at the Email Chief, and would let him or her know the time and date of when the email would be deleted from the system.

The method and system of the present invention may also be implemented in combination with one or more inclusion-based or exclusion-based methods as would be apparent to one of skill in the art.

While the present invention has been particularly described with reference to the preferred embodiment, it should be readily apparent to those of ordinary skill in the art that changes and modifications in form and details may be made without departing from the spirit and scope of the invention. While alternative constructions and equivalents may be used, the above description and illustrations should not be taken as limiting the scope of the present invention which is defined by the appended claims.

### SUMMARY OF INVENTION

The above-mentioned drawbacks are overcome and a practical advance is made over the prior art through the method and system of the present invention.

In a first aspect, the invention features a method for sending an email from an email sender to a recipient in a network. The method comprises the authentication of a sender and once verified, delivering the email to the recipient.

In another aspect of the invention, a method for sending the sender's email address along with a unique fingerprint key to an email management system for verification is provided. This email management system, hereinafter, is referred to as the Email Chief (see FIG. 1). The Email Chief comprises one or multiple interconnected computers residing at a single or multiple locations. The method comprises a secured or non-secured communication between the email recipient's email server or client and the Email Chief for registration/authentication purposes.

In another aspect of the invention, a simple and effective method of differentiating spammers from non-spammers is provided. The method comprises verifying the sender's fingerprint key and deducting sender's anti-spam points before acknowledging the recipient's email server or client to deliver the email.

In another aspect of the invention, a system for registering email senders and issuing and verifying the said fingerprint keys and the said anti-spam points is provided. The system comprises the Email Chief for issuing and verifying the fingerprint keys, and issuing and deducting the points. The system makes available an online registration form, and when the sender completes the form, the system would issue a certain number of free (no charge) anti-spam points, hereinafter referred to as Pass Points. One or more files are available to the Email Chief for determining whether the email sender's address is registered, whether the email sender's fingerprint key is correct, and whether the email sender's points are sufficient.

In another aspect of the invention, a system for automatically inserting said fingerprint keys to the message for the sender. And for occasions where manual insertion of said fingerprint key to the sender's message is required, convenient cut-and-paste processes are provided.

In another aspect of the invention, a method of requesting a sender to register at the Email Chief is provided. The method comprises the steps of: 1) sender sending an email to the recipient, 2) the recipient's email server or email client communicating with the Email Chief to determine whether the sender has provided the fingerprint key in the email, 3) in cases either the sender has not provided the fingerprint key or the sender has provided an incorrect fingerprint key, the Email Chief asking the recipient's server to hold the email, and 4) the Email Chief sending a message to the sender requesting the sender to register.

In another aspect of the invention, a method of acknowledging delivery of the email and deducting the anti-spam points is provided. The method comprises the steps of: 1) the Email Chief checking the file to verify the sender is registered and the provided fingerprint key is correct, 2) acknowledging the recipient's email server or email client to deliver the email, and 3) deducting the appropriate anti-spam points from the sender.

In another aspect of the invention, a method enabling legitimate advertisers to buy advertisement points hereinafter referred to as Ad Points, from the Email Chief operator, and enabling the Email Chief operator to reward email recipients for their earned Ad Points. The method comprises the steps of: 1) advertiser purchasing Ad Points from Email Chief operator, 2) advertiser sending emails to recipient, 3) Email Chief acknowledging the recipient's server or email client to deliver the email, 4) Email Chief deducting the Ad Points from the advertiser, and 5) Email Chief operator rewarding email recipients earned Ad Points.

In another aspect of the invention, a system enabling email recipients to set one or more values for charging advertisers' Ad Points. The system comprises one or more records, for each email recipient, of the number of Ad Points he or she would like to charge for each email going to him or her. The system comprises the capability to deduct a fixed or varied number of points if the sender's anti-spam points are issued through the registration process; and the capability to deduct the number of points required by the recipient if the sender's anti-spam points are purchased from the Email Chief operator.

In another aspect of the invention, a system capable of limiting the number of email accounts from which each individual could redeem Ad Points for reward.

In another aspect of the invention, a system capable of increasing or decreasing, on a fixed or varied schedule, an account's Pass Points to any chosen value or range.

In another aspect of the invention, a system capable of catering to the language of the user during registration, or for any other interaction with the system.

In another aspect of the invention, a system enabling domain owners to issue anti-spam points to email users for emails delivered only to within that same domain. These domain restricted anti-spam points are hereinafter referred to as Dom Points.

In another aspect of the invention, a system enabling email users to purchase anti-spam points for the safe passage of their solicited emails. These safe passage anti-spam points are hereinafter referred to as Safe Points. Safe Points are typically used by mailer sending out large quantities—quantities much larger than Pass Point accounts would allow—of solicited emails. In effect, the sender provides the recipient a guaranty that the email message would not be considered spam. Such solicited emails, for example, include periodic newsletters, responses to inquiries, and automatic notifications.

In another aspect of the invention, a system optionally providing a notification period to senders who have not registered to be notified without having their email being held up or blocked by a new user of this invention. During the notification period, senders who have not registered would receive a reminder to go register each time the Email Chief delivers their message to a new user of this invention.

In another aspect of the invention, a system capable of tracking registered users' email usage patterns to establish user classification.

The differences between prior arts and the present invention are numerous and significant.

1) The present invention is not rule-based or keyword-based, thus there is no danger of filtering away an important email. It starts protecting an email user immediately after his email server or client is communicating with the Email Chief.

2) There is no need to change the current email protocols—information exchanged between the email server or client and the Email Chief is the encoded string, and the authenticating process can be easily implemented by writing a computer program to interact with both the email server or client program and the Email Chief. It is no more complex than the programs run by many email servers for filtering emails.

3) With the fingerprint key, a user is protected from spammers stealing his or her identity or email address to send out spams.

4) Only a one-time registration is required for the email sender. Once registered, the system will automatically replenish the anti-spam points of the email users after a fixed or varied period of time has elapsed. The number of emails permitted to be sent using the present invention within a certain period of time thus is limited, effectively distinguishing spammers from normal email users.

5) The user registration process is meant to incur some cognitive costs for the email sender. Users are able to omit sensitive information if they so desire.

6) The sender would need to register only once at the Email Chief for all participating email servers or email clients to verify the identity of the sender. It is much more feasible and convenient than previous solutions that require registration at each email server.

7) Comparing with the challenge-response systems, the present invention does not require the recipient to build a trusted list. Once registered, a legitimate sender does not need to answer challenge questions each time he or she sends an email to a recipient who does not have his or her email address in the trusted list.

8) Normal usage of sending and receiving emails would not incur any expense to the sender. High volume users could acquire Dom Points, or purchase Safe Points which are refunded if the recipient takes no action to indicate that the message is spam.

9) The present invention enables the email recipients to set a personal threshold for charging Ad Points. Different people with different opportunity costs can charge different number of Ad Points and redeem them later for money, goods, and/or services.

10) Users holding Safe Point or Ad Point accounts would use secured fingerprint keys providing high security from unauthorized use and access.

The present invention creates a legitimate venue for email marketing. The advertisers can buy Ad Points and set a threshold value for sending out each email. If the recipient's threshold value is lower than the advertiser's threshold value, then the email will be delivered, and if not, the email will not be delivered. For a recipient, he or she sets a threshold value according to his or her opportunity cost. If receiving the email pays him or her acceptable price, he or she is better off to read the email; on the other hand, if the email's value is lower than his or her threshold value, the email will not get through.

Hereinafter, an email bearing Ad Points will be referred to as Ad email.

Similarly, an email bearing Dom, Free, or Safe Points will be referred to as Dom email, Free email, or Safe email, respectively.

There are still other differences, both major and minor, between the prior arts and the present invention. Those differences just listed, however, suffice to show that the prior arts are only marginally pertinent to the present invention. It has been useful to discuss it here, however, as the comparison highlights some of the advantages of the present invention. More advantages are discussed in the following sections.

### DETAILED DESCRIPTION

Description and Operation of Invention

The present invention will now be described with reference to the accompanying drawings, which are provided as illustrative examples of preferred embodiment of the present invention.

FIG. 1 depicts a preferred embodiment of a system performing the functions stated in the present invention. The system includes a sender's computer S, a recipient's computer R, the sender's SMTP email server MO, the recipient's email server MI, and the Email Chief C for registration/authentication purposes. The present invention can be deployed at the recipient's email server MI or at the recipient's email client software R, and at the Email Chief C. The Email Chief C has the function for registration, authentication, and maintenance of database.

The recipient's communications device may be any communications device capable of receiving electronic mail or instant messages, such as a computer running mail client software, a Web-enabled wireless telephone, a wireless personal digital assistant, a pager, or the like. For discussion purposes, the following discussion considers a general-purpose computer running mail client software.

In this preferred embodiment, the anti-spam points are categorized into four types: Pass points, Dom points, Safe points, and Ad points. The Pass points and Dom points are issued free of charge, while the Safe points and Ad points are required to be purchased.

Pass points are typically used by people who could be described as “normal email users.” These are people who do not send out huge volume of emails. Any email user could obtain Pass points free of charge after completing a registration form online.

Dom points are typically issued by domain owners to users belonging to their domain who have the need to send large quantities of emails to email addresses within their own domain. Emails that are sent using Dom points could only be received by email addresses having the same domain name as the sender. For example, using Dom points, an email from john@aaa.com could be sent to mary@aaa.com, and not to jane@bbb.com.

Safe points are typically purchased and used by businesses or by people who sends out large quantities of solicited emails. Safe points guarantee that the emails would get delivered. Examples of solicited emails include newsletters, automatic confirmation email for purchases, email replies from customer service representatives, car rental reminders, bill payment notices, etc. For each email, the senders would need to purchase an amount of Safe points adequate to cover for the number of emails addresses they wish to send to.

Purchased Ad points are typically used by reputable email marketers who are mindful of the negative effects of spamming their potential customers. For each advertisement email, the email marketer would set a limit on the number of Ad points offered to the recipients. The advertisement email would only be delivered to recipients who have set a threshold value for charging paid Ad Points that is lower than the value of Ad points offered.

In terms of its function for registration, the Email Chief C can send registration requests to email senders that are not in the current pool of registered users, can communicate with email senders, can issue a fingerprint key for each email address after a successful registration, can issue a certain amount of free Pass Points for the email address, and can replenish or infuse it with more Pass Points after a fixed or varied period of time. These free Pass Points will be deducted by a fixed or varied number each time the user sends out an email to the email servers adopting the present invention. These free Pass Points will be automatically replenished for the user after a fixed or varied period of time has elapsed. The amount of free Pass Points is chosen such that they are ample for normal email users, and at the same time not ideal for spamming (According to BrightMail Inc., an average spammer sends out 250,000 emails each day, so the chosen amount of free Pass points can be very large). For example, if one Pass point is good for sending an email to a single email address, a user is issued 3,000 Pass points per calendar month subject to the following usage rate limitations: 50 Pass points per minutes, limited to 200 Pass points per any 10-minute period, 500 Pass points per calendar day, and 1500 Pass points per calendar week.

Those organizations and users having a legitimate need to send more emails than the Pass Point quota can purchase Safe Points to meet their high volume needs. The cost of Safe Points is refundable to the buyer once the email bearing the Safe Points, or Safe Email, has been accepted by the email recipient. On the other hand, if the recipient claims that the Safe email is spam, the Safe Points used for delivering the email to that recipient are forfeited.

Those advertisers having a need to send out unsolicited commercial emails can purchase Ad Points from the company running the Email Chief. These paid Ad Points are different from the free Pass Points in that they may be deducted by a threshold value set by the recipient. The Email Chief would keep a record of which email addresses have received paid commercial emails, and it can reward money, goods, and/or services to these recipients when they redeem their earned Ad Points.

In terms of its function for authentication, the Email Chief can communicate with the recipient's email server or email client to compare the sender's fingerprint key with the record in the databases, can deduct the appropriate types of anti-spam points from the email senders, and can command the recipient's email server or email client to make the verified email available to the recipient.

With reference to FIG. 1, in this embodiment the present invention is installed on: a) the sender S to provide the convenience for inserting the fingerprint key automatically or manually into the email message; b) the Email Chief C to provide functions such as user registration, authentication, and maintenance of databases; and c) the recipient's incoming email server MI to provide functions such as communication with Email Chief C, taking instructions to hold, delete, or deliver emails to the Recipient R. In step 1, the sender S sends out the email to the outgoing email server MO; in step 2, the outgoing server MO transmits the email to the recipient's incoming email server MI; before making the email available for the recipient R, the incoming server MI contacts the Email Chief C in step 3, by sending an encoded string which contains the sender's profile including, but not limited to the sender's email address, the recipient's email address, MI's identification code, the sender's fingerprint key (if provided); if the Email Chief C can match the fingerprint key with the one in the record for the given email address, it will, in step 4, deduct the appropriate anti-spam points of the sender S and send an acknowledgment to the incoming email server MI or the recipient's email client software to instruct it to make the email available for downloading; in step 5, when the recipient R checks his or her email, the email will be delivered to him or her. On the other hand, if in step 3, the Email Chief C can not find the fingerprint key, or the fingerprint key is invalid, the Email Chief C will send an email to the original email sender S and will ask S to register at C; the registration request is sent through steps 6 and 7; in step 8, the sender S goes to the Email Chief C to get registered; the Email Chief C will offer the sender a unique fingerprint key and some free Pass Points. After a successful registration, the Email Chief C can then continue with step 4 to acknowledge making the email available for downloading at the incoming email server MI; if in step 3, the sender runs out of free anti-spam points, he or she can elect to purchase Ad Points or Safe Points, depending on his or her needs. If step 8 is never carried out, and the email server MI is not able to receive an acknowledgment, the email server MI or email client software can elect to delete the email after a certain period of time or to add a flag to the message and let the recipient choose further actions.

A few scenarios are described in detail with reference to FIG. 1.

In one scenario, sender S has not registered. With reference to FIG. 1, in step 1, the sender S sends the email to the outgoing email server MO; in step 2, the outgoing server MO transmits the email to the recipient's incoming email server MI; before making the email available for the recipient R, the incoming server MI contacts the Email Chief C in step 3, by sending an encoded string which contains the sender's email address, the recipient's email address, MI's identification code; in this scenario the Email Chief C can not find the fingerprint key, and therefore sends an email to the original email sender S asking S to register at C; the registration request is sent through steps 6 and 7; in step 8, the sender S goes to the Email Chief C to get registered; the Email Chief C will offer the sender a unique fingerprint key and some free Pass Points. After a successful registration, the Email Chief C can then continue with step 4 to acknowledge making the email available for downloading at the incoming email server MI. If step 8 is never carried out or not carried out satisfactorily, and the email server MI is not able to receive an acknowledgment, the email server MI or email client software can elect to delete the email after a certain period of time or to add a flag to the message and let the recipient choose further actions.

In a second scenario, the sender S is a registered user. With reference to FIG. 1 again, in step 1, the sender S sends the email to the outgoing email server MO; in step 2, the outgoing server MO transmits the email to the recipient's incoming email server MI; before making the email available for the recipient R, the incoming server MI contacts the Email Chief C in step 3, by sending an encoded string which contains the sender's email address, the recipient's email address, MI's identification code, the sender's fingerprint key (if provided); if the Email Chief C can match the fingerprint key with the one in the record for the given email address, it will, in step 4, deduct the appropriate amount of Pass points of the sender S and send an acknowledgment to the incoming email server MI or the recipient's email client software to instruct it to make the email available for downloading; in step 5, when the recipient R checks his or her email, the email will be delivered to him or her. On the other hand, if in step 3, the Email Chief C can not find the fingerprint key, or the fingerprint key is invalid, the Email Chief C will send an email to the original email sender S asking S to validate the fingerprint key at C; the validation request is sent through steps 6 and 7; in step 8, the sender S accesses the Email Chief C's web site and enters the correct fingerprint key. After a successful validation, the Email Chief C can then continue with step 4 to acknowledge making the email available for downloading at the incoming email server MI; if in step 3, the sender runs out of free Pass Points, he or she can elect to purchase Ad Points or Safe Points, depending on his or her needs. If step 8 is never carried out or not carried out satisfactorily, and the email server MI is not able to receive an acknowledgment, the email server MI or email client software can elect to delete the email after a certain period of time or to add a flag to the message and let the recipient choose further actions.

In a third scenario, sender S has purchased Safe points. With reference to FIG. 1 furthermore, in step 1, the sender S sends the email to the outgoing email server MO; in step 2, the outgoing server MO transmits the email to the recipient's incoming email server MI; before making the email available for the recipient R, the incoming server MI contacts the Email Chief C in step 3, by sending an encoded string which contains the sender's email address, the recipient's email address, MI's identification code, the sender's fingerprint key (if provided); if the Email Chief C can match the fingerprint key with the one in the record for the given email address, it will, in step 4, deduct from sender S′ account the appropriate amount of Safe points, and send an acknowledgment to the incoming email server MI or the recipient's email client software to instruct it to make the email available for downloading; in step 5, when the recipient R checks his or her email, the email will be delivered to him or her. On the other hand, if in step 3, the Email Chief C can not find the fingerprint key, or the fingerprint key is invalid, the Email Chief C will send an email to the original email sender S asking S to validate the fingerprint key at C; the validation request is sent through steps 6 and 7; in step 8, the sender S accesses the Email Chief C's web site and enters the correct fingerprint key. After a successful validation, the Email Chief C can then continue with step 4 to acknowledge making the email available for downloading at the incoming email server MI; if in step 3, the sender runs out of Safe points, the Email Chief C will send an email to the original email sender S asking S to purchase Safe points; the validation request is sent through steps 6 and 7; in step 8, the sender S accesses the Email Chief C's web site and buys more Safe points. After acquiring more Safe points, the Email Chief C deducts the appropriate amount of Safe points from S's account, and then continues with step 4 to acknowledge making the email available for downloading at the incoming email server MI. If step 8 is never carried out or not carried out satisfactorily, and the email server MI is not able to receive an acknowledgment, the email server MI or email client software can elect to delete the email after a certain period of time or to add a flag to the message and let the recipient choose further actions.

In a fourth scenario, sender S has purchased Ad points. With reference to FIG. 1 yet again, in step 1, the sender S sends the email to the outgoing email server MO; in step 2, the outgoing server MO transmits the email to the recipient's incoming email server MI; before making the email available for the recipient R, the incoming server MI contacts the Email Chief C in step 3, by sending an encoded string which contains the sender's email address, the recipient's email address, MI's identification code, the sender's fingerprint key (if provided); if the Email Chief C can match the fingerprint key with the one in the record for the given email address, and verifies that the limit on the number of Ad points offered to the recipients meets or exceeds the threshold value for charging paid Ad Points set by the recipient R, then C deduct from sender S′ account the number of Ad points that matches R's threshold value, and credits them to R's account. In step 4, C then send an acknowledgment to the incoming email server MI or the recipient's email client software to instruct it to make the email available for downloading; in step 5, when the recipient R checks his or her email, the email will be delivered to him or her. If, in step 3, C verifies that the limit on the number of Ad points offered to the recipients does not meet or exceed the threshold value for charging paid Ad Points set by the recipient R, then C send a command, in step 4, to the incoming email server MI or the recipient's email client software to instruct it to delete the email. On the other hand, if in step 3, the Email Chief C can not find the fingerprint key, or the fingerprint key is invalid, or Ad points is depleted or inadequate, the Email Chief C will, in step 4, send a command to the in incoming email server MI or the recipient's email client software to instruct it to delete the email. In the case where Ad points is depleted, in step 5, C would send and email to S notifying that Ad points ran out and to provide a link to a web site for accessing a detailed report on this email advertisement campaign.

In a fifth scenario, the sender S is a registered user and has acquired Dom points. With reference to FIG. 1 once more, in step 1, the sender S sends the email to the outgoing email server MO; in step 2, the outgoing server MO transmits the email to the recipient's incoming email server MI; before making the email available for the recipient R, the incoming server MI contacts the Email Chief C in step 3, by sending an encoded string which contains the sender's email address, the recipient's email address, MI's identification code, the sender's fingerprint key (if provided); if the Email Chief C can match the fingerprint key with the one in the record for the given email address, it will, either deduct the appropriate amount of Pass points of the sender S if the recipient R's email address does not share the same domain as the sender, or deduct the appropriate amount of Dom points of the sender S if the recipient R's email address shares the same domain as the sender; and, in step 4, send an acknowledgment to the incoming email server MI or the recipient's email client software to instruct it to make the email available for downloading; in step 5, when the recipient R checks his or her email, the email will be delivered to him or her. On the other hand, if in step 3, the Email Chief C can not find the fingerprint key, or the fingerprint key is invalid, the Email Chief C will send an email to the original email sender S asking S to validate the fingerprint key at C; the validation request is sent through steps 6 and 7; in step 8, the sender S accesses the Email Chief C's web site and enters the correct fingerprint key. After a successful validation, the Email Chief C can then continue with step 4 to acknowledge making the email available for downloading at the incoming email server MI; if in step 3, the sender runs out of Dom points, Pass points get deducted instead; and if both Dom and Pass points are out, he or she can elect to purchase Ad Points or Safe Points, depending on his or her needs. If step 8 is never carried out or not carried out satisfactorily, and the email server MI is not able to receive an acknowledgment, the email server MI or email client software can elect to delete the email after a certain period of time or to add a flag to the message and let the recipient choose further actions.

In the preferred embodiment, the fingerprint key is a string chosen by the email sender during registration. The fingerprint key is typed in the body of the email as if it is part of the email message. Each fingerprint key shares a common characteristic with all other fingerprint keys. It is this common characteristic which makes the fingerprint key recognizable by this invention's software that is installed on the email server MI. Prior to releasing the email to the recipient R, MI removes the fingerprint key from the email, and therefore it is not seen by the recipient R.

In the preferred embodiment, two methods are available to safeguard the Ad points from being stolen during the transmission of the Ad email. In the first method, the email marketer is required to logon to the Email Chief's web site to send the Ad email through the site's web page. In addition, the email marketer would have to purchase Ad points for each mailing, i.e., buying one batch of Ad points good for sending one email to a list of recipients once; and sending the same email again would require the purchase of a new batch of Ad points. In the second method, the email marketer would use a digital signature certificate generated by cryptographic software, as is well known in the art, for the authentication of the Ad email.

In another embodiment of the present invention, the fingerprint key expires periodically and a new fingerprint key is automatically generated for the registered user.

In another embodiment of the present invention, the function of holding the email and communicating with the Email Chief can be done by the recipient's email client.

In another embodiment of the present invention, if step 8 is never carried out, the email server can elect to edit the email by adding a flag in the header of the email, and let the recipient decide what to do with the email. The recipient can elect to write a rule of filtering in his or her email client software to filter the emails with the flag to a separate folder or to delete it directly.

In another embodiment of the present invention, the email server MI can elect to make available the email for the recipient immediately and then communicate with the Email Chief C.

In another embodiment of the present invention, the recipient's threshold value for charging paid Ad Points can be omitted from the system, and all anti-spam points, whether free or purchased will be treated the same way, and each delivery of an email will result in a deduction of a predetermined fixed or varied number of points from the email sender.

In another embodiment of the present invention, if a sender has not registered with the Email Chief, either the Email Chief or the incoming email server of the recipient would send an email to notify the sender that his or her email is on-hold and will not be delivered until he or she registers at the Email Chief, and would let him or her know the time and date of when the email would be deleted from the system.

The method and system of the present invention may also be implemented in combination with one or more inclusion-based or exclusion-based methods as would be apparent to one of skill in the art.

While the present invention has been particularly described with reference to the preferred embodiment, it should be readily apparent to those of ordinary skill in the art that changes and modifications in form and details may be made without departing from the spirit and scope of the invention. While alternative constructions and equivalents may be used, the above description and illustrations should not be taken as limiting the scope of the present invention which is defined by the appended claims.

1. A system of using anti-spam points for email processing, comprising:
a) means for providing one or more web addresses, with choice of languages, accessible by email users;
b) means for allowing said email users to register to become said system's registered email users;
c) means for interacting with said email users through said web addresses to ensure that a real human being is interacting with said system;
d) means for generating one or more unique fingerprint keys for said registered email users, said fingerprint key is a string of ASCII characters assigned to or chosen by said registered email users, and said fingerprint key is optionally encrypted;
e) means for automatically or manually inserting said fingerprint keys into said registered email users' email messages;
f) means for issuing a fixed or varied number of one or more types of anti-spam points to said registered email users, and adding a fixed or varied number of said anti-spam points to said registered email users' accounts after a fixed or varied period of time has elapsed;
g) means for limiting the number of said anti-spam points said registered email users could use within a period of time;
h) means for setting a same or different rate limit on the usage of said anti-spam points for each sub-periods of equal or non-equal duration within a period of time;
i) means for deducting one or more of said anti-spam points from said registered email users' account for each of their email message that is delivered to an email recipient who is or isn't a registered email user;
j) means for monitoring said registered users' email usage patterns, and making adjustments to the availability of said registered users' anti-spam points;
k) means for selling various types of said anti-spam points to said registered email users, and tracking each registered email user's anti-spam points by type and quantity;
l) means for owners of email servers to register and establish accounts for their servers to earn and redeem said anti-spam points;
m) means for tracking the number of anti-spam points earnings processed by each email server;
n) means for maintaining one or more databases containing registered email user profiles;
o) means for extracting from an email message its sender's profile for comparison with the record in said databases;
p) means for encoding said sender's profile into a string or field;
q) means for receiving from an email recipient's email server one or more encoded or non-encoded strings or fields containing email sender's profile, and decoding said strings or fields for comparison with the record in said databases;
r) means for comparing the information from said strings or fields with said email senders' record in said databases;
s) means for sending a message to said email sender requesting registration if said system has determined that said email sender's profile has not been created or has not met certain preset criteria;
t) means for commanding said email recipient's email servers to deliver said email message to said email recipient if said sender's profile has met or exceeded certain preset criteria;
u) means for registered email users to earn anti-spam points by receiving advertiser's emails;
v) means for notifying owners of registered email servers and registered email users of the anti-spam points they have accumulated, and providing ways for them to redeem their accumulated anti-spam points for money, goods or services;
w) means for limiting the number of registered accounts assigned to each individual email user;
x) means for enabling said registered email users to send emails via one or more provided web pages;
y) means for said registered email senders to set one or more threshold values or ranges for an email's available anti-spam points to be charged;
z) means for said registered email recipients to set one or more threshold values or ranges for accepting the delivery of an email;
aa) means for said registered email recipients to set one or more threshold values or ranges for accepting the delivery of one or more types or categories of emails;
bb) means for domain owners to issue anti-spam points to registered email users belonging to their own domain for emails delivered only to within their own domain;
cc) means for authenticating said registered email senders, optionally with the use of cryptographic software generated digital signatures;
dd) means for setting, or for newly registered email recipients to set, a fixed or varied initial period of time for permitting all incoming emails to be delivered to said newly registered email recipient;
ee) means for inserting text messages and/or hyperlinks to said registered email senders' email messages prior to their delivery to said registered email recipients;
ff) means for assigning one or more serial numbers to each email.

2. The system of claim 1, wherein said recipient's email server in q) and t) can be substituted by said recipient's email client software or a plug-in to any available email client software.

3. The system of claim 1, wherein means in a) can be provided as a telephone number or facsimile number for registration.

4. The system of claim 1, wherein said amount of anti-spam points is variably issued in accordance with said sender's category and registration process.

5. The system of claim 1, wherein said fingerprint key is either revealed to, or concealed from the email recipient; and wherein said fingerprint key is valid for a limited time duration and a new fingerprint key is generated for said registered email users when the current fingerprint key expires.

6. The system of claim 1, wherein said databases of email users include a subset or a super set of fields corresponding to said email users.

7. The system of claim 1, wherein said encoded string is plain text, or an output of said required information from any kind of encoding algorithm that is possibly used by one skilled in the art.

8. The system of claim 1, wherein said sender's email is held in said recipient's email server, or in said recipient's own storage media as specified by said recipient's email client.

9. The system of claim 1, wherein said email recipients are allowed to redeem their earned anti-spam points for money, goods, or services when said anti-spam points in their accounts have reached a threshold value, or when the monetary value associated with said anti-spam points has reached a threshold value, or when said recipients make a request for redemption.

10. The system of claim 1, wherein the monetary value of the purchase of a number of paid anti-spam points is equivalent to or different from the monetary value of the redemption of those same numbers of anti-spam points.

11. The system of claim 1, wherein any of the means in a) thru ee) can be included or excluded in any combination thereof.

12. A method for controlling the delivery of email for the system of claim 1, comprising the steps of:
a) recipient's email server or client receiving an email from a sender, said email including an address field containing said sender's email address, a message field optionally containing said sender's fingerprint key issued by said system, optionally containing the type and number of anti-spam point, and optionally containing said sender's threshold value or range for paying out anti-spam points;
b) recipient's email server or client encoding said sender's email address, fingerprint key, threshold value or range for paying out anti-spam points, the type and number of anti-spam points born by said email, said recipient's email address, recipient's threshold value or range for charging paid anti-spam points, or any combination thereof;
c) recipient's email server sending said encoded information to said system for authentication;
d) if said sender's email address is not on record, or said sender's fingerprint key does not match that of said record, or said sender's anti-spam points are insufficient, then said system: i. denying authentication; ii. acknowledging said recipient's email server of denied authentication, and requesting said email server or email client to hold said sender's email for further discretion; iii. sending a registration request to said sender; iv. approving said email if said sender registers within a predetermined period of time; v. deleting said email or adding a flag to said email if said sender fails to register within the predetermined period of time;
e) said system validating authentication and making said email available for delivery, optionally inserting text messages and/or hyperlinks to the body of said email, and deducting appropriate quantities and appropriate types of anti-spam points from said sender's record; and adding appropriate quantities and appropriate types of anti-spam points to recipient's record.

13. The method of claim 12, wherein said registration request is issued from the recipient's email server or email client.

14. The method of claim 12, wherein step v. is replaced with “adding a flag to said email and/or making said email available to said recipient for deleting, downloading, filtering and/or allowing exploitation of sender's email by said recipient.”

15. The method of claim 12, wherein said sender elects to omit sending said fingerprint key, and while said system requests for registration, the request provides a link to a web address where said sender inputs his or her fingerprint key.
